(19) United States
(12) Patent Application Publication
(10) Pub. No.: US 2002/0056684 A1
(43) Pub. Date: May 16, 2002

(54) Multilayer filter element

(76) Inventor: Gunnar-Marcel Klein, Spiegelberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/982,527

(22) Filed: Oct. 19, 2001

Related U.S. Application Data
(63) Continuation of application No. PCT/EP00/03547, filed on Apr. 19, 1999.

(30) Foreign Application Priority Data
Apr. 19, 1999 (DE) 199 17 690.6

(51) Int. Cl. B01D 39/16

(52) U.S. Cl. 210/491; 210/493.5; 210/496; 210/508; 210/767

(57) ABSTRACT

A multi-layer filter element for filtering fluids, in which a plurality of layers of filter media follow each other in succession in the direction of flow through the filter. All of the individual filter layers are preferably made of synthetic fibers, especially polyester fibers. The successive filter layers exhibit an increasing degree of filter fineness in the direction of flow through the filter, and the filter material contains at least one filter layer arranged on the inflow side of the filter which is composed of a meltblown fiber nonwoven web, especially a polyester fiber web.

### CROSS REFERENCE TO RELATED APPLICATIONS

This application is a continuation of international application no. PCT/EP00/03547, filed Apr. 19, 2000 designating the United States of America, the entire disclosure of which is incorporated herein by reference. Priority is claimed based on Federal Republic of Germany patent application no. DE 199 17 690.6, filed Apr. 19, 1999.

### BACKGROUND OF THE INVENTION

The present invention relates generally to filter elements, and particularly to filter elements for filtering gases or liquids. Especially, the invention relates to multi-layer filter elements, in which several layers of filter media follow one another in succession in the direction of flow through the filter and in which all the individual layers are composed of synthetic fibers.

It is generally known to combine different filter materials in filter elements to produce optimum filter characteristics for the particles to be filtered and the liquid and/or gas which flows through the filter. For instance German patent application no. DE-A 44 43 158 discloses the use of a meltblown nonwoven web or fleece as the filter medium in a gas stream together with a carrier or support material that serves exclusively for stabilization.

Furthermore, U.S. Pat. No. 5,591,335 (=WO 96/34673) discloses arranging a plurality of filter layers composed of a meltblown nonwoven web on a support layer in a hollow cylindrical filter element. Together, the layers form a replaceable filter element which can be utilized in a filter arrangement

U.S. Pat. Nos. 5,496,627 and 5,766,288 (=WO 95/17946) disclose the successive arrangement of filter media of synthetic fibers with graduated filter fineness. Here, the filter fineness of the filter layers increases in the direction of flow through the filter.

U.S. Pat. Nos. 5,427,597 and 5,591,335 (=WO 96/34673) disclose the arrangement of one or more filter layers composed of a nonwoven web produced by a meltblowing process on a support layer which serves to stabilize the filter material. The filter action of the support layer is negligible compared to that of the other layers.

Despite the efforts of the prior art, the heretofore available filter elements do not exhibit sufficient heat resistance and long-term stability to gaseous and liquid media to satisfy today's requirements, and there has remained a need for improved filter materials.

### SUMMARY OF THE INVENTION

Thus, it is the object of the present invention to improve filter performance of the multilayer medium through improved adaptation or matching of the individual layers in terms of a pre-filtration/fine-filtration while maintaining the same filter permeability.

It is also an object of the invention to provide a multi-layer filter construction which exhibits an improved overall filter action and can maintain it over a long period of time.

These and other objects have been achieved by providing a multilayer filter element of the type described above in which the filter layers all exhibit successively increasing filter fineness in the direction of flow through the filter medium and at least one filter layer arranged on the inflow side is composed of a meltblown nonwoven web.

The use of such a filter layer of a meltblown nonwoven web enables the use of fibers having a fiber diameter which is reduced by up to an order of magnitude. This results in an improved particle retention capacity while maintaining the same fractional filtration efficiency or an improved fractional filtration efficiency while maintaining the same particle retention capacity and thus achieves improved filter performance.

### BRIEF DESCRIPTION OF THE DRAWINGS

The invention will be described in further detail hereinafter with reference to illustrative preferred embodiments shown in the accompanying drawings in which:

FIG. 1 is a schematic illustration of an example of an arrangement of three successive layers of filter media, and FIG. 2 is a schematic illustration of an example of a star-folded filter material according to the invention.

### DETAILED DESCRIPTION OF PREFERRED EMBODIMENTS

In contrast to the filter layers of the prior art, the filter layer 1 arranged on the outflow side (filtered side) of the filter material of the present invention is not made of cellulose. This allows the use of synthetic fibers with a fiber diameter that is reduced by up to an order of magnitude. In a particularly preferred embodiment, the synthetic fibers are polyester fibers.

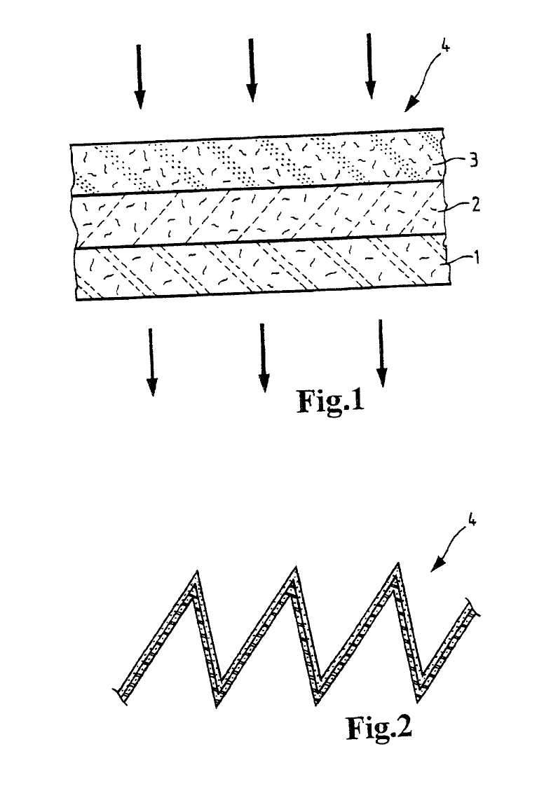

FIG. 1 shows a multilayer filter element according to the invention. At least one filter layer 3 on the inflow side (unfiltered side) is made of a meltblown nonwoven web. Due to the use of fibers having a diameter of <3 [symbol] m, which is reduced compared to the fibers of nonwoven filter webs produced by other techniques, nonwoven webs produced by the meltblown technique exhibit improved filter performance.

The starting material for the meltblown nonwoven web may be, for example, polypropylene (PP), especially for non-aggressive liquids, or polyether sulfone (PES), which is suitable also for filtering fuel or hydraulic oils up to a temperature of about 80 [symbol] C. It is, however, preferred to use polyester fibers.

A progressive arrangement of successive filter layers with different degrees of filter fineness provides a pre-filter/fine-filter effect and thereby increases the performance of the overall system. Arranging the meltblown layer on the inflow side makes it possible to utilize the superior particle retention capacity of meltblown nonwoven webs. This results in only minor amounts of particles reaching the subsequent fine filter layers. By suitably adapting or matching the degrees of separation and particle retention capacities achieved by the individual layers, a homogenous loading of the entire filter material may be achieved, and thus a maximum filter performance is attained with the material used.

FIG. 1 depicts an example of a succession of three layers of filter media. It is clearly evident for a person skilled in the art, however, that the filter element according to the invention may also have two layers or more than three layers.

In a further preferred embodiment, in the case of three filter media layers, a third layer (2) may be arranged between filter medium (3) on the inflow side and filter medium (1) on the discharge side. This center layer may comprise a polyester nonwoven web and, preferably, a meltblown nonwoven web. If the center layer comprises a meltblown nonwoven web, it preferably will have an area weight of 15-100 g/m² and a thickness of 0.05-0.6 mm.

If the third layer is made of a simple polyester nonwoven web, the area weight is preferably between 15 and 150 g/m², and the thickness is preferably between 0.05 and 1.0 mm.

Particularly preferred arrangements are described below:

a) Two-layer medium

Layer 1 on the filtered (clean) side: polyester nonwoven web; area weight 50-150 g/m², thickness 0.2-1.2 mm

Layer 3 on the unfiltered (raw) side: polyester meltblown web; area weight 15-150 g/m², thickness 0.05-0.8 mm

b) Three-layer medium

Layer 1 on the filtered (clean) side: polyester nonwoven web; area weight 30-100 g/m², thickness 0.1-0.6 mm

Center layer 2: polyester nonwoven web; area weight 30-100 g/m², thickness 0.1-0.6 mm

Layer 3 on the unfiltered (raw) side: polyester meltblown web; area weight 15-150 g/m², thickness 0.05-0.8 mm

c) Three-layer medium

Layer 1 on the filtered (clean) side: polyester nonwoven web; area weight 30-100 g/m², thickness 0.1-0.6 mm

Center layer 2: meltblown nonwoven web; area weight 15-100 g/m², thickness 0.05-0.6 mm

Layer 3 on the unfiltered (raw) side: polyester meltblown web; area weight 10-100 g/m², thickness 0.05-0.6 mm

d) Three-layer medium

Layer 1 on the filtered (clean) side: polyester meltblown web; area weight 15-100 g/m², thickness 0.05-0.6 mm

Center layer 2: polyester nonwoven web; area weight 30-150 g/m², thickness 0.1-1.0 mm

Layer 3 on the unfiltered (raw) side: polyester meltblown web; area weight 15-100 g/m², thickness 0.05-0.6 mm

It should be noted that this list is not exclusive. It will be apparent to a person skilled in the art that other combinations of the filter media layers are also possible within the scope of the invention.

In contrast to the arrangements of multi-layer filter media described in the prior art using at least one cellulose-based filter layer, the substantial advantage of the present invention is that the use of filter layers composed entirely of synthetic materials improves heat resistance and long-term stability to gaseous and liquid media. This makes possible long-term use of the filter media in the automotive field, even up to the life of the vehicle.

A further advantage is that the improved filter performance of the polyester nonwoven web arranged on the filtered side as compared to cellulose media provides improved adaptation or matching of the individual layers in terms of pre-filtration/fine-filtration and thus yields improved filter performance of the overall multilayer medium while maintaining the same fluid (e.g., air) permeability. This advantage is achieved by the small fiber diameter and the high porosity of the meltblown non-woven material. The filter action, particularly the separation efficiency, initially increases with the retention of filtered particles during the period of use. The filter fineness of the layer on the inflow side is selected in such a way that through this fine layer a sufficiently long service life of the filter element is achieved.

In an advantageous preferred further embodiment of a filter system according to the invention, the superimposed layers of the filter media are folded into a star shape to form a filter element 4 (cf. FIG. 2). In particular, the layers of the filter media can be joined welded prior to or during the folding process by ultrasonic welding, or they can be joined by surface pressure during the folding process, for example in an embossing and folding machine. The layers can also be bonded with an adhesive, in which case it is preferred to use hot-melt or spray adhesive bonding.

The filter element according to the invention may be used as a fluid filter, for example, as a liquid filter for filtering the lubricating oil of an internal combustion engine of a motor vehicle, or as a filter for filtering gases such as the intake air for an internal combustion engine.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A filter element wherein a plurality of successive layers of filter media follow one another in a direction of flow through the filter; all the individual layers consist of synthetic fibers; the successive filter media layers exhibit respective degrees of filter fineness that increase in the direction of flow through the filter, and at least one filter media layer arranged on an inflow side is composed of a meltblown nonwoven web.

2. A filter element according to claim 1, wherein said synthetic fibers are polyester fibers.

3. A filter element according to claim 1, wherein the meltblown nonwoven web is made of polyester fibers.

4. A filter element according to claim 1, wherein the meltblown nonwoven web arranged on the inflow side is made of polyester fibers and has an area weight in the range from 10 to 150 g/m² and a thickness in the range from 0.05 to 0.8 mm.

5. A filter element according to claim 1, comprising three successive layers of filter media.

6. A filter element according to claim 5, wherein the center layer is composed of a polyester nonwoven web.

7. A filter element according to claim 6, wherein the polyester nonwoven web of said center layer has an area weight in the range from 15 to 150 g/m² and a thickness in the range from 0.05 to 1.0 mm.

8. A filter element according to claim 5, wherein the center layer is composed of a meltblown nonwoven web.

9. A filter element according to claim 8, wherein the meltblown nonwoven web of said center layer has an area weight in the range from 15 to 100 g/m² and a thickness in the range from 0.05 to 0.6 mm.

10. A filter element according to claim 5, wherein the filter layer arranged on the outflow side of the filter element is composed of a meltblown polyester nonwoven web.

11. A filter element according to claim 1, wherein the successive layers of filter media are folded into a star shape.

12. A filter element according to claim 11, wherein the successive layers of filter media are joined together by surface pressure during folding.

13. A filter element according to claim 1, wherein the successive layers of filter media are ultrasonically welded together.

14. A filter element according to claim 1, wherein the successive layers of filter media are joined together by a hot-melt adhesive bonding or spray adhesive bonding.

15. A method of filtering a fluid comprising passing said fluid in a flow direction through a filter element comprising a plurality of successive layers of filter media which follow one another in said flow direction; wherein all the individual layers consist of synthetic fibers; the successive filter media layers exhibit respective degrees of filter fineness that increase in the direction of flow through the filter, and at least one filter media layer arranged on an inflow side of the filter element consists of a meltblown nonwoven web.

16. A method according to claim 15, wherein said fluid is a gas.

17. A method according to claim 16, wherein said gas is intake air for an internal combustion engine.

18. A method according to claim 15, wherein said fluid is a liquid.

19. A method according to claim 18, wherein said liquid is selected from the group consisting of lubricating oils, hydraulic oils and liquid fuels.
